(19) United States
(12) Patent Application Publication
(10) Pub. No.: US 2012/0278716 A1
(43) Pub. Date: Nov. 1, 2012

(54) ELECTRONIC DEVICE HAVING DISPLAY CONTROLLERS FOR PROCESSING CORRELATED MULTIMEDIA CONTENTS AND RELATED MULTIMEDIA PROCESSING METHOD AND SYSTEM

(75) Inventors: Zhou Ye, Foster City, CA (US); Pei-Chuan Liu, Taipei City (TW)

(73) Assignee: CYWEE GROUP LIMITED, Tortola (VG)

(21) Appl. No.: 13/093,860

(22) Filed: Apr. 26, 2011

(51) Int. Cl. G06F 3/14

(52) U.S. Cl. 715/717

(57) ABSTRACT

An electronic device includes a first display controller, a second display controller and a second interface (UI) controller. The first display controller is implemented for processing a first multimedia content, and accordingly generating a first output. The second display controller is implemented for processing at least a second multimedia content associated with the first multimedia content while the first display controller is processing the first multimedia content, and accordingly generating a second output. The first display controller is coupled to a first UI controller and the first UI controller is for receiving the first output and controlling a first output device according to the received first output. The second UI controller is coupled to the second processor and implemented for receiving the second output and controlling a second output device according to the received second output.

### BACKGROUND OF THE INVENTION

1. Field of the Invention

The present invention relates to an electronic device for multimedia processing and a related method and system, and more particularly, to an electronic device for multimedia processing that is capable of playing a multimedia program at a preferable output device while delivering side information of the multimedia program to an interactive interface on the electronic device, and a multimedia processing method and system thereof.

2. Description of the Prior Art

Due to advances in technology and the increased popularity of the Internet, playback of multimedia content via Internet protocol has become more and more common. An Internet user will often encounter pop-ups, embedded commercials and side-bar advertisements along with a desired multimedia program, which are usually viewed as unnecessary distractions. To make the matter worse, the above-mentioned campaign gimmicks are rarely content-oriented.

Therefore, there is a need for an innovative design for multimedia processing that is capable of playing a multimedia program at a preferable output device while delivering side information of the multimedia program to an interactive interface.

### SUMMARY OF THE INVENTION

One of the objectives of the present invention is therefore to provide an electronic device for multimedia processing and a related multimedia processing method and system that solve the aforementioned problem.

According to one aspect of the present invention, an exemplary electronic device for multimedia processing is disclosed. The exemplary electronic device for multimedia processing includes a first display controller, a second display controller and a second user interface (UI) controller. The first display controller is utilized for processing a first multimedia content, and accordingly generating a first output. The second display controller is utilized for processing at least a second multimedia content associated with the first multimedia content while the first display controller is processing the first multimedia content, and accordingly generating a second output. The first display controller is coupled to a first UI controller and the first UI controller is for receiving the first output and controlling a first output device according to the received first output. The second UI controller is coupled to the second processor and utilized for receiving the second output and controlling a second output device according to the received second output.

According to another aspect of the present invention, an exemplary multimedia processing method is disclosed. The exemplary multimedia processing method includes processing a first multimedia content provided by a first content provider, and accordingly generating a first output; processing at least a second multimedia content provided by a second content provider, associated with the first multimedia content while the first multimedia content being processed, and accordingly generating a second output; and transmitting the first output to a first display device and the second output to a second display device.

According to yet another aspect of the present invention, a multimedia processing system is disclosed. The multimedia processing system includes a first output device, and an electronic device externally coupled to the first output device. The electronic device includes a first display controller, a second display controller, and a second user interface (UI) controller. The first display controller is utilized for processing a first multimedia content, and accordingly generating a first output. The second display controller is coupled to the first display controller and utilized for processing at least a second multimedia content associated with the first multimedia content while the first display controller is processing the first multimedia content, and accordingly generating a second output. The second UI controller is coupled to the second processor and utilized for receiving the second output and controlling a second output device according to the received second output. The first output device including a first UI controller coupled to the first display controller and utilized for receiving the first output and controlling the first output device according to the received first output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a multimedia system according to an embodiment of the present invention.

FIG. 2 is a schematic diagram of a multimedia system according to a first exemplary application of the present invention.

FIG. 3 is a schematic diagram of a multimedia system according to a second exemplary application of the present invention.

FIG. 4 is a schematic diagram of the multimedia system according to a third exemplary application of the present invention.

FIG. 5 is a flowchart illustrating multimedia processing according to a first embodiment of the present invention.

FIG. 6 is a functional block diagram of a multimedia system according to another embodiment of the present invention.

FIG. 7 is a flowchart illustrating multimedia processing according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

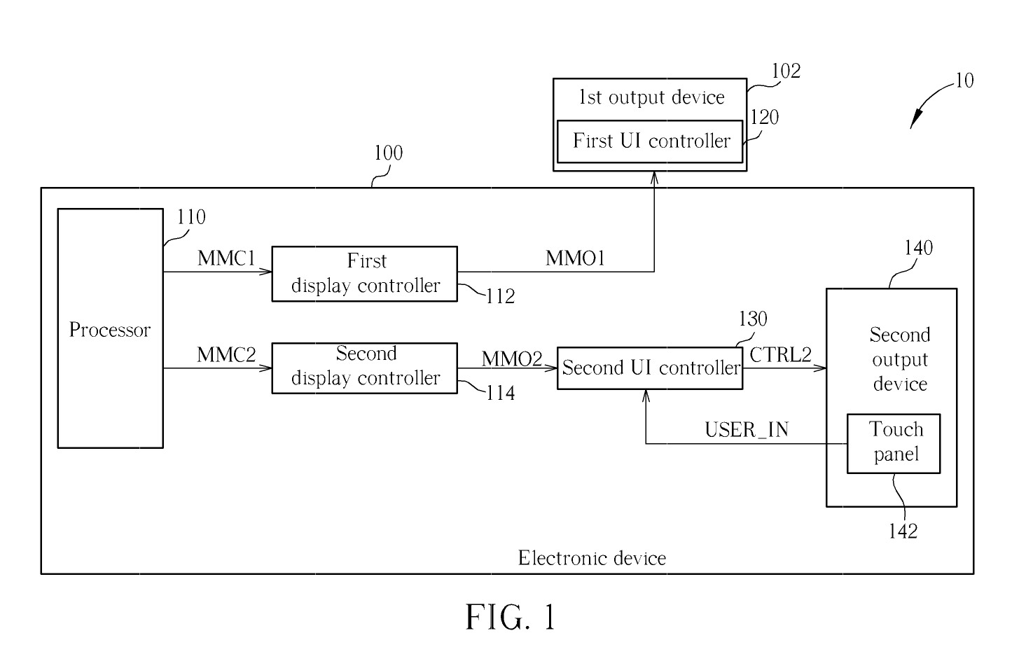

Please refer to FIG. 1, which is a functional block diagram of a multimedia system 10 according to an embodiment of the present invention. The multimedia system 10 includes an electronic device 100 and a first output device 102 which includes a first user interface (UI) controller 120. The electronic device 100 is externally coupled to the first output device 102 and includes a processor 110 (e.g., a central processing unit), a first display controller 112 and a second display controller 114, and a second UI controller 130. The first display controller 112 is coupled to the processor 110, for processing a first multimedia content MMC1 and accordingly generating a first output MMO1. The second display controller 114 is coupled to the processor 110, for processing at least a second multimedia content MMC2 associated with the first multimedia content MMC1 while the first display controller 110 is processing the first multimedia content MMC1, and accordingly generating a second output MMO2. That is, the first display controller 112 and the second display controller 114 operate in a parallel processing fashion for dealing with the incoming correlated multimedia contents (i.e., the first multimedia content MMC1 and the second multimedia content MMC2). The first UI controller 120 is coupled to the first display controller 112, and utilized for receiving the first output MMOL and generating a control signal CTRL1 to control the first output device 102 according to the received first output MMO1. The second UI controller 160 is coupled to the second display controller 114, and utilized for receiving the second output MMO2 and generating a control signal CTRL2 to control a second output device 140 according to the received second output MMO2. The second UI controller 130 further receives a user interaction input USER_IN generated in response to playback of the received second output MMO2 at the second output device 140. In this exemplary embodiment, the second output device 140 is integrated in the electronic device 100 and has a touch panel 142 for generating the user interaction input USER_IN. In an alternative design, however, the second output device 140 controlled by the second display controller 114 may be disposed outside of the electronic device 100. By way of example, the electronic device 100 may be a handheld/portable device, such as a smart-phone, a tablet computer or a laptop computer, and the first output device 102 may be a television, a liquid crystal display (LCD) monitor or a projector.

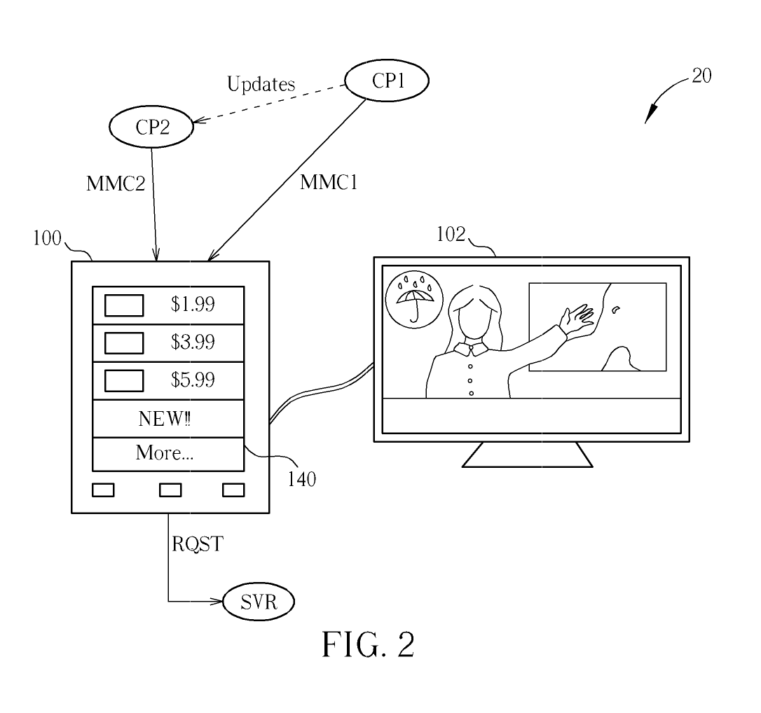

Please note that the second multimedia content MMC2 is associated with the first multimedia content MMC1, but the first multimedia content MMC1 and the second multimedia content MMC2 are provided by different content providers. Please refer to FIG. 2, which is a schematic diagram of a multimedia system 20 according to a first exemplary application of the present invention. The structure of the multimedia system 20 shown in FIG. 2 is based on that of the multimedia system 10 shown in FIG. 1. In FIG. 2, the first multimedia content MMC1 is provided by a first content provider CP1 and the second multimedia content MMC2 is provided by a second content provider CP2 different from the first content provider CP1. The second content provider CP2 has to periodically retrieve content updates from the first content provider CP1, in order to maintain the association between the first multimedia content MMC1 and the second multimedia content MMC2. In this example, the first multimedia content MMC1 may be an internet protocol television (IPTV) program and the second multimedia content may include a plurality of commercials associated with the IPTV program, such as promotions of merchandise appearing in the IPTV program, campaigns of entertainers in the IPTV program, other related programs, artist information, commentary, etc. The IPTV program is processed by the first display controller 112 of the electronic device 100 (a smart-phone in this example) and then output to the first output device 102 (a television in this example). The commercials associated with the IPTV program are processed by the second display controller 114 and output to the second output device 140 (e.g., a touch-controlled display screen of the smart-phone). The second display controller 114 sends a request signal RQST to a remote server SVR when the user interaction input USER_IN is generated via the touch panel 142 (e.g., a touch panel included in the touch-controlled display screen of the smart-phone). The request signal RQST can be used to purchase the merchandise, book or a ticket of an upcoming concert of the entertainers, and/or activate a predetermined action on the remote server SVR.

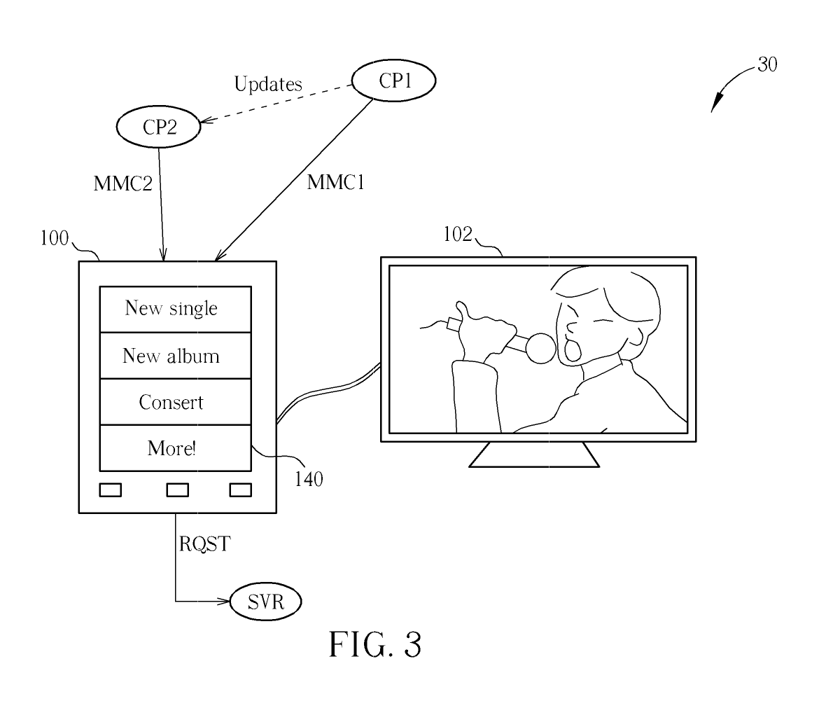

Please refer to FIG. 3, which is a schematic diagram of a multimedia system 30 according to a second exemplary application of the present invention. The structure of the multimedia system 30 shown in FIG. 3 is similar to that of the multimedia system 20 shown in FIG. 2, with the major difference being that the first multimedia content MMC1 in the multimedia system 30 is now an audio streaming program and the second multimedia content MMC2 includes a plurality of subsidiary information about the audio streaming program, such as album promotions, concert information, artist information, lyrics, commentary, etc. As in the above example, the second display controller 114 can send the request signal RQST to purchase music, book a ticket online, and/or enable a predetermined action on the remote server SVR.

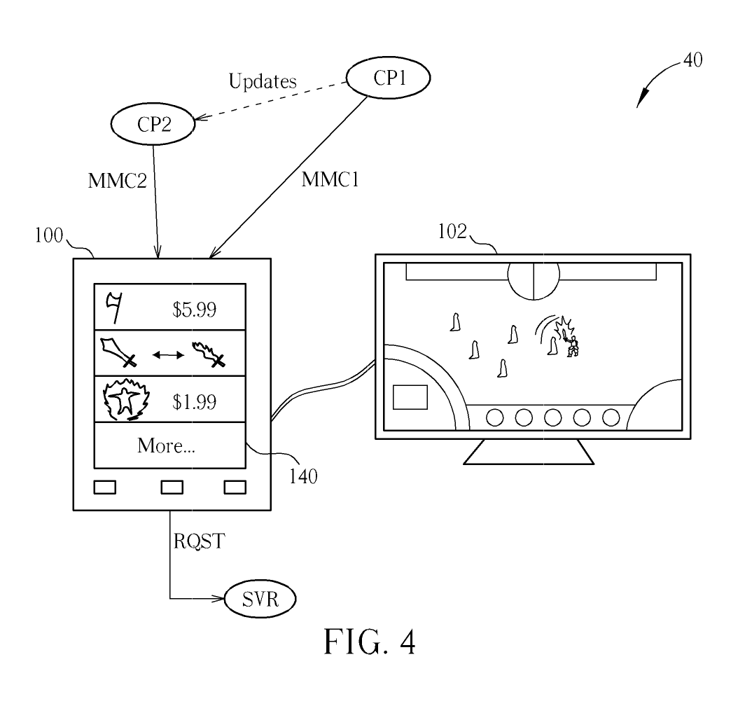

Please refer to FIG. 4, which is a schematic diagram of the multimedia system 40 according to a third exemplary application of the present invention. The structure of the multimedia system 40 shown in FIG. 4 is similar to that of the multimedia systems 20, 30 shown in FIG. 2 and FIG. 3, with the major difference being that the first multimedia content MMC1 is now an on-line game, and the second multimedia content MMC2 includes a plurality of ancillary additions of the on-line game, such as tradable items from other hosts, cheat tips, equipment updates, limited edition items, etc. In the multimedia system 40, the request signal RQST may be used to trade items with other hosts, download the newest updates, purchase a limited edition item, and/or activate a predetermined action on the remote server SVR.

Note that the above-mentioned exemplary applications/embodiments are merely for illustrative purposes, and are not meant to be limitations of the present invention. Those skilled in the art should readily appreciate that making modifications to the applications/embodiments without departing from the spirit of the present invention is feasible. For example, the first multimedia content MMC1 may also be an online cooking course.

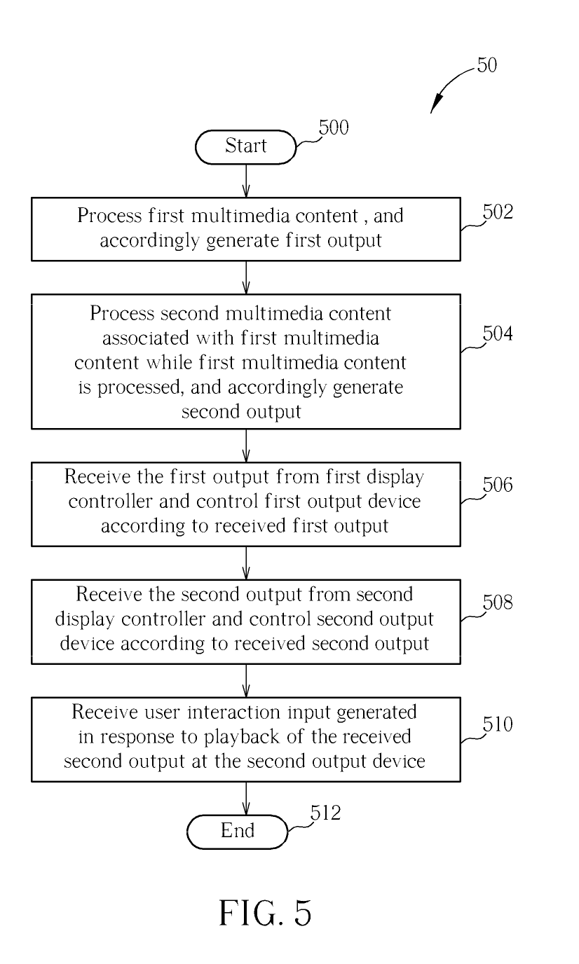

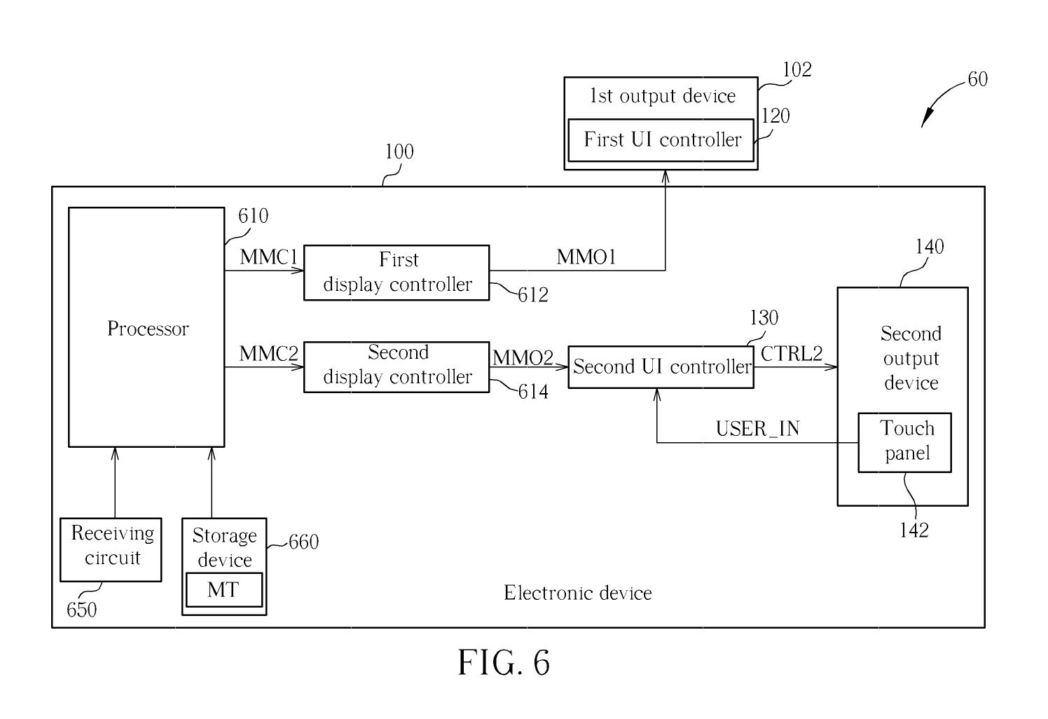

The above-mentioned operations of the multimedia system 10 may be briefly summarized into multimedia processing method 50 as shown in FIG. 5. Please note that if essentially the same results are available, these steps do not have to follow the implementation order shown in FIG. 6 to execute (i.e. should the result be substantially the same, the steps are not required to be executed in the exact order shown in FIG. 6). The multimedia processing method 50 includes (but is not limited to) the following steps:

Step 500: Start.

Step 502: Process a first multimedia content MMC1, and accordingly generate a first output MMO1.

Step 504: Process at least a second multimedia content MMC2 associated with the first multimedia content MMC1 while the first multimedia content MMC1 is processed, and accordingly generate a second output MMO2.

Step 506: Receive the first output MMOL from a first display controller 612 and control a first output device 102 according to the received first output MMO1.

Step 508: Receive the second output MMO2 from a second display controller 614 and control a second output device 140 according to the received second output MMO2.

Step 510: Receive a user interaction input generated in response to playback of the received second output MMO2 at the second output device 140.

Step 512: End.

The multimedia processing 50 may be employed by the multimedia system 10 shown in FIG. 1. As a detailed description and possible modifications can be readily surmised by referring to the above paragraphs, further description is omitted here for brevity.

Please refer to FIG. 6, which is a functional block diagram of a multimedia system 60 according to another embodiment of the present invention. In FIG. 6, a structure of the multimedia system 60 is similar to that of the multimedia system 10 and therefore adopts some of the symbols shown in FIG. 1 for simplicity. In detail, a receiving circuit 650 and a storage device 660 are added to the multimedia system 60. The receiving circuit 650 is a network interface of the multimedia system 60, coupled to the second display controller 614 via the processor 610 and utilized for receiving a plurality of candidate second multimedia contents CMMC2 associated with the same first multimedia content MMC1. Note that, the receiving circuit 650 can be a wired or wireless network interface, such as a WiFi or cable network interface, without departing from the spirit of the present invention. The storage device 660 is also coupled to the second display controller 614 via the processor 610 and utilized for storing a mapping table MT. In this embodiment, the mapping table MT records a plurality of indication values N₁-Nₘ mapped to the plurality of candidate second multimedia contents MMC2, respectively, where each indication value indicates a number of times a corresponding candidate second multimedia content is selected, and the second display controller 614 selects at least the second multimedia content MMC2 from the plurality of candidate second multimedia contents CMMC2 according to the mapping table MT.

In short, since the second output device 140 is compact and integrated in the electronic device 100, the display area of the second output device 140 is constrained and unlikely to be able to display all contents at once. Therefore, the multimedia system 60 sorts the candidate second multimedia contents CMMC2 at a local end according to respective frequencies of selection which are updated and recorded in the mapping table MT before one or more of the candidate second multimedia contents CMMC2 are displayed on the display area of the second output device 140. More specifically, the sorting prioritizes the candidate second multimedia contents CMMC2 in accordance with the number of times of selections of the content. The most frequently selected second multimedia content(s) would be automatically selected and then displayed on the display area of the second output device 140; additionally, the corresponding indication values in the mapping table MT will be updated, for example, by an increment of one. The less frequently selected second multimedia content(s) would not be displayed until the user scrolls down the displayed page for selecting other second multimedia content(s). Similarly, a corresponding indication value in the mapping table MT will be updated each time a second multimedia content is selected and displayed on the display area of the second output device 140. With the help of the mapping table MT which keeps track of a user's selection of preferred second multimedia contents, the second display controller 614 controls the second output device 140 with a limited display area to show the most frequently selected second multimedia content(s).

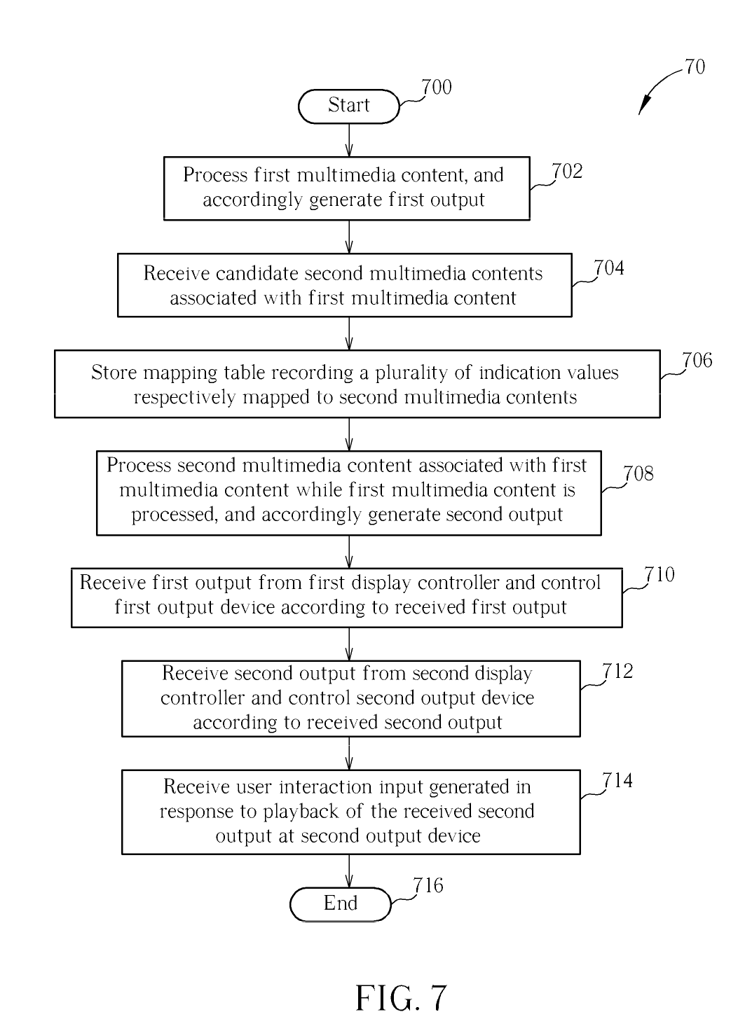

The operations of the multimedia system 60 may be briefly summarized into multimedia processing method 70 as shown in FIG. 7. Please note that if essentially the same results are available, these steps do not have to follow the implementation order shown in FIG. 6 to execute (i.e. should the result be substantially the same, the steps are not required to be executed in the exact order shown in FIG. 7). The multimedia processing method 70 includes (but is not limited to) the following steps:

Step 700: Start.

Step 702: Process a first multimedia content MMC1, and accordingly generate a first output MMO1.

Step 704: Receive a plurality of candidate second multimedia contents CMMC2 associated with the first multimedia content MMC1 from the receiving circuit 650.

Step 706: Store a mapping table MT recording a plurality of indication values respectively mapped to a plurality of second multimedia contents.

Step 708: Process at least the second multimedia content MMC2 associated with the first multimedia content MMC1 while the first multimedia content MMC1 is processed, and accordingly generate a second output MMO2.

Step 710: Receive the first output MMOL from a first display controller 612 and control a first output device 102 according to the received first output MMO1.

Step 712: Receive the second output MMO2 from a second display controller 614 and control a second output device 140 according to the received second output MMO2.

Step 714: Receive a user interaction input generated in response to playback of the received second output MMO2 at the second output device 140.

Step 716: End.

The multimedia processing 70 may be employed by the multimedia system 60 shown in FIG. 6. As a detailed description and possible modifications can be surmised by referring to the above paragraphs, further description is omitted here for brevity.

To sum up, by using the exemplary multimedia system according to the present invention, a user can have a multimedia program played at a preferred output device while side information of the multimedia program are delivered to an interactive interface, to thereby exploit the instant, informative, and content-oriented benefit provided by the side information.

Those skilled in the art will readily observe that numerous modifications and alterations of the device and method may be made while retaining the teachings of the invention.

What is claimed is:

1. An electronic device for multimedia processing, comprising:
a first display controller, coupled to a first user interface (UI) controller, for processing a first multimedia content, and accordingly generating a first output, wherein the first user U1 controller is for receiving the first output and controlling a first output device according to the received first output;
a second display controller, for processing at least a second multimedia content associated with the first multimedia content while the first display controller is processing the first multimedia content, and accordingly generating a second output; and
a second UI controller, coupled to the second processor, for receiving the second output and controlling a second output device according to the received second output.

2. The electronic device of claim 1, wherein the second UI controller further receives a user interaction input generated in response to playback of the received second output at the second output device.

3. The electronic device of claim 2, wherein the second output device is integrated in the electronic device and comprises a touch panel for generating the user interaction input.

4. The electronic device of claim 1, wherein the first multimedia content is provided by a first content provider, and the second multimedia content is provided by a second content provider different from the first content provider.

5. The electronic device of claim 4, wherein the first multimedia content includes an internet protocol television (IPTV) program, and the second multimedia content includes commercials regarding the IPTV program.

6. The electronic device of claim 4, wherein the first multimedia content includes an audio streaming program, and the second multimedia content includes subsidiary information about the audio streaming program.

7. The electronic device of claim 4, wherein the first multimedia content includes an on-line game, and the second multimedia content includes at least an ancillary addition of the on-line game.

8. The electronic device of claim 1, further comprising:
a receiving circuit, coupled to the second display controller, for receiving a plurality of candidate second multimedia contents associated with the first multimedia content; and
a storage device, coupled to the second display controller, for storing a mapping table recording a plurality of indication values mapped to the plurality of candidate second multimedia contents, respectively, wherein each indication value indicates a number of times a corresponding candidate second multimedia content is selected, and the second display controller selects at least the second multimedia content from the plurality of candidate second multimedia contents according to the mapping table.

9. A multimedia processing method, comprising:
processing a first multimedia content provided by a first content provider, and accordingly generating a first output;
processing at least a second multimedia content provided by a second content provider, associated with the first multimedia content while the first multimedia content being processed, and accordingly generating a second output; and
transmitting the first output to a first display device and the second output to a second display device.

10. The multimedia processing method of claim 9, further comprising:
receiving a user interaction input generated in response to a playback at the second output device.

11. The multimedia processing method of claim 10, wherein the second output device comprises a touch panel for generating the user interaction input.

12. The multimedia processing method of claim 9, wherein the first multimedia content includes an internet protocol television (IPTV) program, and the second multimedia content includes commercials regarding the IPTV program.

13. The multimedia processing method of claim 9, wherein the first multimedia content includes an audio streaming program, and the second multimedia content includes subsidiary information about the audio streaming program.

14. The multimedia processing method of claim 9, wherein the first multimedia content includes an on-line game, and the second multimedia content includes at least an ancillary addition of the on-line game.

15. The multimedia processing method of claim 9, further comprising:
providing a plurality of candidate second multimedia contents associated with the first multimedia content; and
storing a mapping table recording a plurality of indication values mapped to the plurality of candidate second multimedia contents, respectively, wherein each indication value indicates a number of times a corresponding candidate second multimedia content is selected, and at least the second multimedia content is selected from the plurality of candidate second multimedia contents according to the mapping table.

16. A multimedia processing system, comprising:
an electronic device, externally coupled to the first output device, the electronic device comprising:
a first display controller, for processing a first multimedia content, and accordingly generating a first output;
a second display controller, for processing at least a second multimedia content associated with the first multimedia content while the first display controller is processing the first multimedia content, and accordingly generating a second output; and
a second interface (UI) controller, coupled to the second processor, for receiving the second output and controlling a second output device according to the received second output; and
a first output device, comprising:
a first UI controller, coupled to the first display controller and the first output device, for receiving the first output and controlling a first output device according to the received first output.

17. The multimedia processing system of claim 16, wherein the second output device is integrated in the electronic device and comprises a touch panel for generating a user interaction input in response to playback of the received second output at the second output device.

18. The multimedia processing system of claim 16, wherein the first multimedia content is provided by a first content provider, and the second multimedia content is provided by a second content provider different from the first content provider.

19. The multimedia processing system of claim 16, further comprising:
a receiving circuit, coupled to the second display controller, for receiving a plurality of candidate second multimedia contents associated with the first multimedia content; and
a storage device, coupled to the second display controller, for storing a mapping table recording a plurality of indication values mapped to the plurality of candidate second multimedia contents, respectively, wherein each indication value indicates a number of times a corresponding candidate second multimedia content is selected, and the second display controller selects at least the second multimedia content from the plurality of candidate second multimedia contents according to the mapping table.
